(19) United States
(12) Patent Application Publication
(10) Pub. No.: US 2007/0198287 A1
(43) Pub. Date: Aug. 23, 2007

(54) Method and apparatus allowing individuals to enroll into a known group, dispense tokens, and rapidly identify group members

(76) Inventor: Christopher Scott Outwater, Santa Barbara, CA (US)

Correspondence Address: Christopher Outwater, 329 San Ysidro Rd, Santa Barbara, CA, 93108, US

(21) Appl. No.: 11/655,809

(22) Filed: Jan. 18, 2007

Related U.S. Application Data
(60) Provisional application No. 60/760,473, filed on Jan. 20, 2006.

(51) Int. Cl. G06Q 10/00; G06Q 30/00

(52) U.S. Cl. 705/1; 705/35

(57) ABSTRACT

A method and apparatus are disclosed by which a holder of an ATM or other pre-existing account may submit to biometric data collection and receive an identification token, and/or a value token. The tokens are associated with the account record, biometric data, and other previously or subsequently gathered information. Subsequent presentation of the token for access or transaction can automatically trigger a verification of the biometric data and/or recall of associated data, whereby security checks of the individual may be carried out more efficiently.

### CROSS REFERENCE TO RELATED APPLICATIONS

This non-provisional patent application claims the benefit under 35 USC 119(e) of the like-named provisional application No. 60/760,473 filed with the USPTO on Jan. 20, 2006. This patent application is further related to non-provisional patent application Ser. No. 11/590,604, entitled METHOD AND APPARATUS FOR IMPROVED TRANSACTION SECURITY USING A TELEPHONE AS A SECURITY TOKEN, filed with the USPTO on Oct. 30, 2006, as a continuation-in-part of the same parent application.

### FIELD OF THE INVENTION

The present invention relates generally to a system and method for identification of people or their property. More particular, the invention automatically issues identification to ATM or other kiosk users and enroll them in an identification database. More particular still, issues tokens from the ATM and/or kiosk that can have specific dollar value(s) and can also be used to identify the user and/or the user's property.

### STATEMENT REGARDING FEDERALLY SPONSORED RESEARCH OR DEVELOPMENT

Not Applicable

### REFERENCE TO COMPUTER PROGRAM LISTING APPENDICES

Not Applicable

### BACKGROUND OF THE INVENTION

The classic security triangle is: “who you are”, provided by biometric measures such as voice print, fingerprint, face scan, etc.; “what you know”, for instance, a password, pass-phrase or other secret knowledge; and “what you have”, a token such as a key, artifact, tag, card, etc. In various combinations this triangle has been used to ensure varying levels of access to secure areas.

In the field of people seeking secure entry or transactions, individuals may be classified: known low-risk, known high-risk, known neutral, and unknown. If an individual was quickly and efficiently classifiable as a known low-risk, no further security examination is required. Depending upon the application, the same may be true of known neutral parties. In this manner, a less efficient security check can be reserved for those individuals who are either known high-risk, or unknown. The benefit of this accrues to both the individual, because checkpoint delays are shorter, and to the security/transaction providing entity, since the recurring costs will be reduced.

“What you have” may be a key, or other token, such as a RFID tag, an ATM, credit card, or ID card such as a driver's license. Such a token is, by design, difficult to replicate. Bank cards and ID cards frequently employ diverse mechanisms to make convincing replication difficult: elaborate printing, uncommon materials, holographic images, embossing, magnetic encoding, fluorescent inks.

Replication of a “what you have” token may require access to the original, such as when one has a duplicate key made. If the bearer keeps the original protected and secure, duplication is more difficult, and may become impossible. If the original goes missing, as when lost or stolen, the owner may notice, allowing appropriate protective action to be taken.

“What you know” may be personal information. Particularly common is “mother's maiden name”, which is easy to remember but not often known outside of family contexts. “What you know” might also be a password (especially common with computer accounts), or a number, such as a personal identification number (PIN) common in debit card transactions, or your social security number. The advantage of secret knowledge is that, if well chosen, it can be very hard to guess. The disadvantage is that once revealed, “what you know” is easily transferred or disseminated. Poorly chosen values for “what you know” can be guessed: common examples are people and place names, and words found in the dictionary, since these easily fall prey to “dictionary attacks” where automatic programs systematically try every word in a dictionary (or on a name list) until one works.

Confirmation of “Who you are” has long been provided by picture ID, as when someone checks that yours is the face on the driver's license you just presented. Automatic systems that can recognize human faces are now available. Facial recognition is one of a number of biometric technologies that can recognize a person's identity by examining some aspect of their body. Fingerprint sensors are another biometric technology that reliably recognizes whether the person presenting himself is who the person represents himself to be. Often the problem of identifying “who you are” from biometrics is fairly simple: It is a far more simple problem to determine if the person claiming to be Mr. Smith has Mr. Smith's fingerprints, than it is to determine to whom, of all known persons, a fingerprint belongs. In the former case, the measured fingerprint (or other biometric) merely needs to be compared to the biometric information previously recorded and associated with Mr. Smith: Only one match needs to be tried and if it is good enough, the identity is verified.

Event access, such as to a concert or show, is typically secured by a “what you have” token: a ticket. Previously, this was true of transportation, but the need for increased security calls for the use of an additional side of the security triangle. Now, photo identification is checked against the name on the ticket, and “who you are” is verified, by manual (or, rather, human visual), means.

Present transportation security and some casinos go further: The name on the ticket (token) may be cleared against a no-fly or no-entry list. At check-in or other access areas, and again at other security checkpoint(s), the person is visually compared by security guard to an image or photo ID. The name on the photo ID is compared to name on ticket/token, and the name on the ticket/token has been cleared relative to the no-fly or no entry list.

Such stringent security can be important in areas like transportation, gaming, and event access, but represents an inconvenience. Further, there are several weaknesses to this system.

First, photo IDs are infrequently updated. This is because they are costly and inconvenient to update. Thus a photograph of the named individual is frequently many years out-of-date, making visual comparisons challenging and error prone.

Second, a person's name can take a number of forms, and though an individual may maintain credit cards, tickets, and photo IDs under a particular preferred version of his or her name, this is not a requirement, and aliases are frequently encountered. This makes name comparisons additionally difficult.

Third, the present process of comparing a person to an ID and a name on one document or token to the name on another document or token, takes trained security personnel, and time.

Thus, a need exists for efficiently allowing updates to information associated with a person, such as their photo.

A further need exists for an apparatus and method for quickly and automatically associating people with their identity.

A number of biometric technologies exist, including fingerprints, retinal scans, voice prints, and face scans. Each has various virtues and drawbacks associated with cost, processing time, requirement for physical contact, and active participation by the subject.

In the contemplated field of sets of people seeking secure entry to transportation, an event, to conduct transactions, or make wagers at a casino, the sets of people could be: known low-risk (e.g., airline pilots, police officers, persons who have a clear background check), known high-risk (e.g., persons on a no-fly list), known neutral (e.g., person not appearing on a no-fly list), unknown (e.g., person whose identify has not yet been checked, person who has not been compared to a no-fly list).

If a person was enrolled in a system that provided rapid and reliable classification as a known low-risk or known neutral, the enrollee's access or transaction would be accelerated through any point where security is checked. Using the incentive of the enrollee's own accelerated ID and subsequent speedy entry or transaction and the corresponding convenience, the present invention strives to create the largest group of known enrollees as possible.

The enrollee chooses and pays for an ATM- or kiosk-based enrollment process and token(s) in order to enroll in a database as a known and possibly known low-risk person, and thus have increased chances for accelerated, and thus convenient, identification at chosen, ID enabled, entry/transaction checkpoints for parking, checking ID tagged bags, travel, special events, wagering at casinos, etc.

Thus, there is a need for a system that allows a plurality of “self-serve” enrollment sites where data associated with the reliable identity of a person, preferably including biometrics, can be quickly and easily collected and sent to a secure, central database of known persons, for subsequent access and use by another plurality of checkpoint sites.

Because of the delays inherent in secure travel, or event access, and the need for heightened security, a process for better, faster, more precise identification is needed. The present manual security process can and should be supplemented with automated identification processes.

Further, there is a need for a way of limiting the labor time and cost and excessive patron delay of the identification process, while keeping security at an acceptable level.

The present invention satisfies these and other needs and provides further related advantages.

### OBJECTS AND SUMMARY OF THE INVENTION

The present invention relates to a system for identification of people and issuing tokens to them. Such tokens may have a set monetary value (such as a casino chip). Such tokens may help identify the group enrollee's property. One or more new identification tokens is issued by a system that confirms a person's identity by permitting access to a previously established account by use of a previously issued identification “what you have” token (e.g. an ATM card) preferably with a “what you know” password (e.g. a PIN number), or in the case of a credit card, a person's billing address zip code. Such a transaction may be carried out automatically by an ATM machine, or other kiosk, operating in accordance with the present invention. Such an ATM or kiosk is preferably able to capture the enrollee's facial image. The ATM or kiosk is preferably able to vend identification tokens, the tokens optionally having monetary value. The identification tokens are associated within a database with the person's identification as recorded with the previously existing ATM or credit card account. Preferably, at the time of issuance other data, such as the person's photograph or other biometric signature is collected, though this biometric collection is not required for the present invention to have value. This other data is also associated with the person's record in the database. The database can be checked against known individuals from other databases, such as government no-fly lists, criminal records, etc.

It is an object of this invention to make it possible for a plurality of ATM's, or ATM-like kiosks, to perform a facial image scan or photograph and send the data to an encrypted database where it is associated to the enrollee's ATM account.

It is also an object of this invention to dispense from the kiosk a plurality of tokens associated with the enrollee, and also tied to the enrollee's account and optional facial image, and other biometric information.

It is a further object of this invention to permit an enrollee to elect to input additional personal identification data, such as phone number, cell number, zip code, driver's license number, passport number, etc. into the database.

In addition to the above, it is an object of this invention to accelerate the identification process for enrollee's who by virtue of this enrollment, become known members of a group enjoying the benefits and reasonable expectations of keeping access delays to the minimum necessary for safe and secure access, entry and/or transaction(s).

It is an object of this invention to add or modify a known individual's existing name and financial token number in a remote, secure database during or subsequent to the process of enrolling into a known group.

These and other features and advantages of the invention will be more readily apparent upon reading the following description of a preferred, exemplified embodiment of the invention and upon reference to the accompanying drawings wherein:

### BRIEF DESCRIPTION OF THE DRAWINGS

The aspects of the present invention will be apparent upon consideration of the following detailed description taken in conjunction with the accompanying drawings, in which like referenced characters refer to like parts throughout, and in which:

FIG. 1 is a detailed block diagram of a self-serve kiosk 100 for enrolling an enrollee 102 into a known group;

FIG. 2 is a detailed block diagram showing enrollee 102 at a secure access checkpoint 200;

FIG. 3 is a flowchart for known-group to additional known-groups self-serve enrollment process 300;

FIG. 4 is a flowchart for a data pre-fetch process 400 that preferably occurs prior to enrollee presenting at the checkpoint in response to arranging an itinerary or an event;

FIG. 5 is a flowchart for checkpoint screening process 500, allowing access to an enrollee 102 and denying access to an unknown person; and,

FIG. 6 is a flowchart showing an alternative for screening and confirming that a potential enrollee 202 is, in fact, enrollee 102. While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

The present invention provides an ATM/kiosk-based transaction that enrolls the enrollee into a known-persons database that is defined by multiple data capture, including at least one of biometric, financial, personal history, and information, enabling accelerated, convenient entry or transactions at designated, secure checkpoints. The enrollee elects and agrees to have personal information, data, and records tied to the enrollee's ATM or credit card number and account entered into a secure, central database, and further tied to the enrollee's facial image (or other biometric data) captured at the ATM-based kiosk.

The present invention allows distributing unique tokens, including the central database-enrolled ATM-ID card itself, a barcode tag, and/or RFID tags to the enrollee from the ATM at the time of the transaction, or through the mail or other delivery service.

In addition, the enrollee, as above, can request supplemental ID tokens, including those for minor family members, and also those tokens that would allow a parent or guardian to escort a minor through a secure access checkpoint, even if the parent or guardian is not part of an itinerary or is not remaining with the minor for the duration of the event.

### DEFINITIONS

“Enrollee” is the unique person tied to a unique number and/or set of personal information and data associated with a valid, bank ATM or credit card and corresponding account held by the enrollee.

“ATM” means one of the global network of automatic teller machines linked through a network to financial databases.

“ID database” means the secure, remote database that contains the data of each enrollee of the known group, potentially including financial, biometric, and personal history. As is well known in the art, such remote databases may be localized, or distributed in nature.

“ATM-ID token”, or “ID token” means a unique token (for example barcode, or RFID tag), that can be, through the ID database or directly, tied to biometric data (such as a facial image), and financial (credit card or bank account), personal (phone number, drivers license, passport), and any other data associated with the enrollee captured before, during, or subsequent to the time of enrollment into the ID database. And the ID token can be used at designated transaction points, and/or entry and/or exit ID checkpoints to accelerate identification and/or transactions of the known enrollee(s). In the case of transactions or gambling, the dispensed token(s) would have a specific, designated dollar value both human and machine readable.

“Secure, central database” means a database that can be shared by a plurality of authorized entities, including, but not limited to, banks, airlines, casinos, and authorized clubs - - - such as automobile clubs, and mass transportation agencies, government, and law enforcement agencies.

ATM/kiosk-based enrollment locations will at first be only at traditional ATM's designated by the Banks and Card companies, but later could be at specific ID locations designed specifically for ID enrollment including facial image (or other biometric measure) capture, personal data capture (such as telephone numbers or drivers license,) and/or token distribution. These can be wired or wirelessly connected to the secure, central database.

A plurality of ATM-ID checkpoint locations, where the ATM-ID token is read and scanned and where a Facial Image scan and database match is attempted, is contemplated. These can also be wired or wireless.

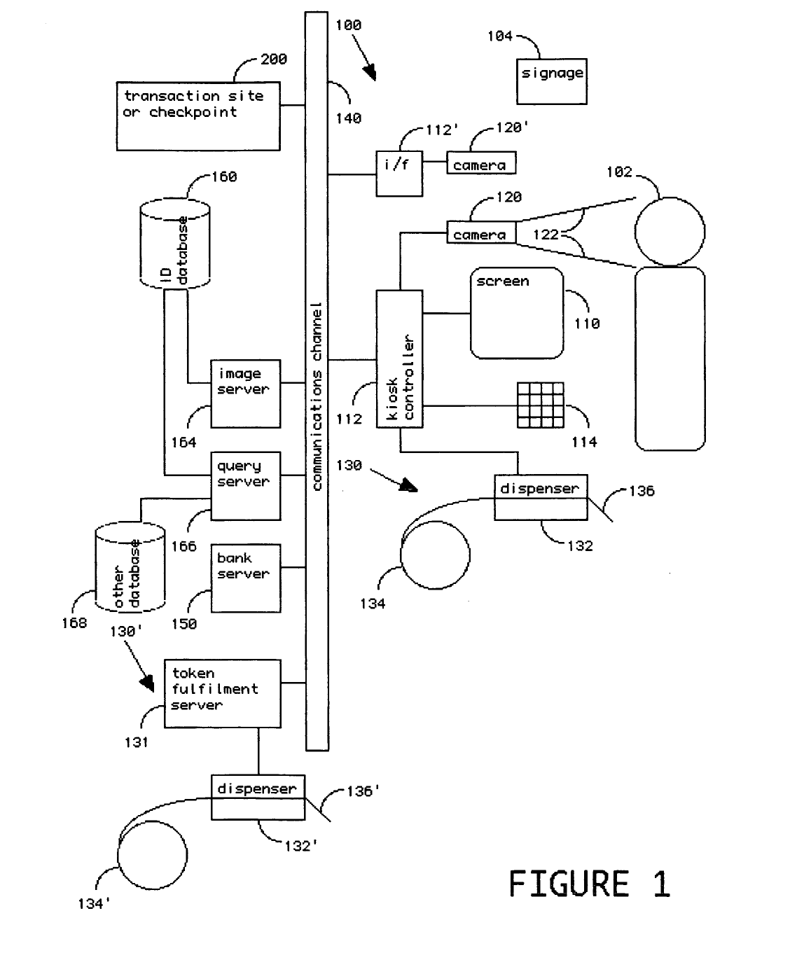

Referring first to FIG. 1, an enrollment method will be described. Enrollee 102 applies at the enrollment kiosk 100 that may be designated with signage 104. Enrollee 102 inserts an existing (previously issued) card (not shown), such as an ATM card or credit card of the prior art, or token (not shown) into the kiosk 100 keypad/card reader 114 and inputs a corresponding personal identification number (PIN, of the prior art) or code into keypad 114. This data is sent via the controller 112 and the communication channel 140 to the bank server 150. Enrollee 102 observes screen 110 and reads whether the input (the reading of the card or token and the corresponding PIN) is verified by the bank server 150.

The enrollee is presented an option preferably on screen 110 of enrolling in the known group whose identity will be stored on ID database 160. If enrollee 102 chooses the enrollment option and presses the proper key on keypad 114, then the terms of the enrollment are preferably shown. If enrollee 102 chooses to proceed, then an option is shown on screen 110 to have the enrollee's face image(s) captured by the camera 120. Camera 120 is connected directly to controller 112. If enrollee 102 chooses the option to have a face image captured, then enrollee 102 presses the proper key on the keypad/card reader 114 and is shown instructions how proceed with the image capture so that the face of enrollee 102 is in the proper position to be captured in field-of-view (FOV) 122 of camera 120 or the FOV (not shown) of camera 120′.

While this preferred embodiment employs facial image capture with camera 120 as the mode of biometric identification, additional or alternative forms of biometric identification may be used instead, using biometric reader 120. Facial image capture is preferred simply because a significant number of cameras 120 or 120′ are presently associated with ATM kiosks currently installed.

In an alternative embodiment, camera 120′ is used which may continuously or periodically capture images of activity in the proximity of kiosk 100. Camera interface 112′ operates independently of controller 112 and preferably communicates images it captures to a remote image server 164. As known in the art, such captured images may be transferred in real time, and are generally searchable by time, and so may be identified by having been captured at the ATM/kiosk 100 during the time of the enrollment transaction.

The image(s) of enrollee 102 are captured and sent via the camera interface 112′ or controller 112 through communication channel 140 to image server 164 and ID database 160. If the image capture is successful, the process is verified on screen 110, preferably with the enrollee's image shown on screen 110. If the image capture is not successful, then the image capture process may be repeated a number of times, as needed.

At this time the face image collected at image server 164 may also be matched against other databases 168 having images of known persons through the query server 166. Such matching, as known in the art, may provide biometric confirmation of the identity of enrollee 102 from previously collected biometric records, or may optionally be matched against police or other official agency records.

Enrollee 102 may be shown on screen 110 a web site URL where the images may be viewed at a later date.

Enrollee 102 is shown on screen 110 the option of obtaining supplemental tokens 136 from the kiosk dispenser 132. If enrollee 102 chooses to proceed, he/she presses the appropriate key on the keypad/card reader 114. The token(s) 136 are prepared from the inventory 134 and dispensed from the dispenser 132.

Enrollee 102 is shown on screen 110 the option of obtaining additional supplemental tokens 136′. Enrollee 102 chooses that option by pressing the appropriate key on the keypad/card reader 114. That input is sent via the controller 112 to communication channel 140 to the token fulfillment center 131 where the additional token(s) 136′ are written from the inventory 134′ and dispensed from the dispenser 132′. The additional token(s) 136′ will be sent via secure mail (e.g., the U.S. Postal Service) or other means.

In another embodiment, the biometric data is written to the token 136 at the kiosk 100 and the dispensed to enrollee 102. This would require a token writer at the kiosk 100, for instance as a part of the preparation by dispenser 132.

In still another embodiment, the biometric data is written to the additional token(s) 136′.

If additional biometric data, such as fingerprint or retina scan are required, but not yet available at the kiosk 100, the enrollee 102 could register that data at another secure location having the appropriate biometric reader, at a later time.

Enrollee 102 is preferably shown on screen 110 a web site URL where he/she may order additional token(s) at a later date.

Before the enrollment and transaction is complete, enrollee 102 agrees to an enrollment fee by pressing the appropriate key on the keypad/card reader 114. That input is sent via the controller 112 and communication channel 140 to the bank server 150 where the appropriate charge is incurred to the enrollee's 102 account.

Subsequently, the enrollee 102 may attempt to access transportation or an event, or attempt a transaction at any of one or more remote checkpoints 200 (one shown).

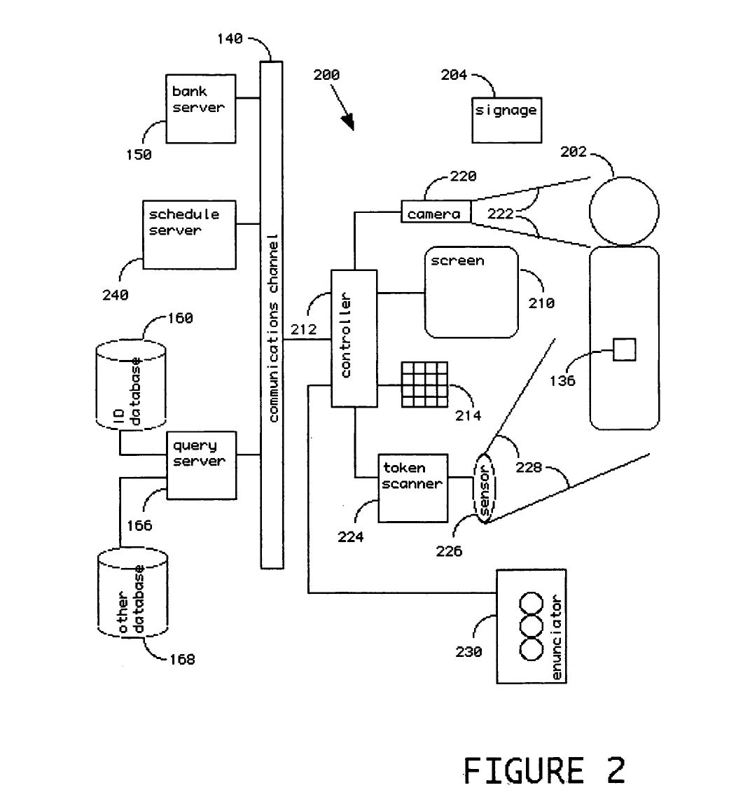

Referring to FIG. 2, a detailed block diagram on one embodiment of checkpoint or transaction site 200 is shown and the associated screening method is described.

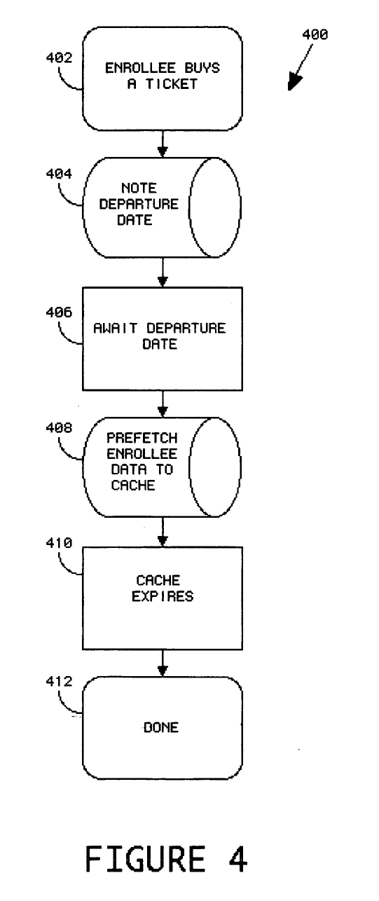

If a valid enrollee 102 (from FIG. 1) arranges to purchase a ticket for travel (e.g., step 402 in FIG. 4), information regarding this transaction, including but not limited to departure date, time, and departure location can be registered through communication channel 140 with schedule server 240. Similarly, if valid enrollee 102 arranges for access to an event that requires secure access, then information regarding the event date, time, and location is registered through communication channel 140 with schedule server 240. In the same way, when an enrollee 102 purchases tokens with dollar value, as in a casino, information regarding this purchase event, including but not limited to a token value, registers through communication channel 140 to the schedule server 240. The schedule server 240 communicates through communication channel 140 to at least one other database, including ID database 160. Enrollee's 102 biometric data (if collected in step 314, below) is fetched and cached and awaits enrollee 102 to arrive at the event checkpoint 200.

A potential enrollee 202 (shown in FIG. 2) arrives at the event/travel site for admission. Potential enrollee 202 is guided to the checkpoint 200 by designated signage 204 that is similar in appearance to the enrollment kiosk's signage 104.

Upon presentation at the checkpoint/transaction site 200 the potential enrollee's token(s) 136/136′ are read by the token scanner 224 when the token(s) come within the range 228 of the token sensor 226. In the preferred embodiment the token is an RFID token. In another embodiment the token could be a barcode, or a bankcard, such as an ATM or credit card. In the case of the magnetic stripe card, enrollee 202 inserts the bankcard into the keypad/card reader 214 and input personal ID data, for example, as previously mentioned, the corresponding PIN.

Additional information and instructions are presented on screen 210, common in the prior art. An example of such instructions would be to enter the appropriate PIN code following the insertion of a bankcard, as above.

At the same time, the potential enrollee's 202 face enters the FOV 222 of the camera 220 and is captured and sent through the controller 212 via communication channel 140 to the query server 166 and at least one other database that might include a security database 168.

If captured biometric is recognized and matched to the expected enrollee 102 data as held in the query server 166 and ID database server 160, or preferably found pre-fetched to schedule server 240; then the potential enrollee 202 becomes recognized as known and accepted enrollee 102. Enrollee 202 will be notified by sound or graphics, such as an enunciator 230, and guided to the known enrollee access/transaction area.

Upon completion of the token 136 scan and the successful biometric match, enrollee 202 may be charged a set fee through the bank server 150 connected through communication channel 140 to the controller 212.

If there is no match, then potential enrollee 202, remains a potential enrollee 202 and is denied access/transaction and is notified by the enunciator 230 to exit the area.

There will also be cases where a potential (valid) enrollee 202 arrives at an access checkpoint 200 in error, such as at the wrong day, time, and/or location. The potential enrollee 202 might present luggage token(s) 136 at a drive up location. Or a casino patron might have dollar tokens 136 not associated with the patron's ID data. The tokens 136 will be scanned by the token reader 224 and sensor 226. This scan data will be sent via the controller 212 to the schedule server 240. If there is no match, then at this time the potential enrollee 202 will be notified that the enrollee is not expected. The potential enrollee 202 will be guided to another area for further information.

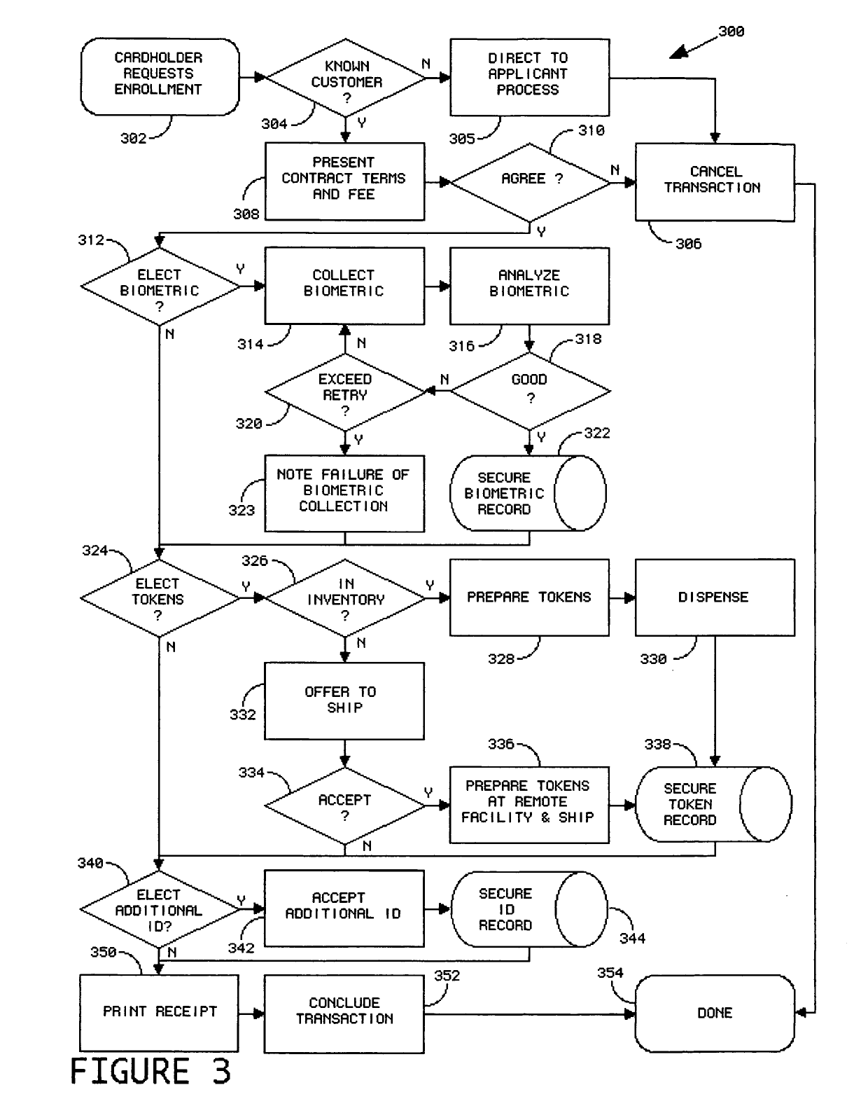

Referring to FIG. 3, which describes the enrollment process from a known group to additional known groups.

Enrollee 102 initiates enrollment process 300 at the signage-designated 104 kiosk/ATM 100. Enrollee 102 inserts a bankcard token (for example, of the prior art) into the keypad/card reader 114 and inputs personal ID information, such as a PIN or a billing address zip code.

If not recognized as a known customer, enrollee 102 is directed in step 305 to an applicant process of the prior art (e.g., applying for an ATM card, or applying for a credit card).

If recognized in step 304, enrollee 102 is shown on screen 110 various options, one of them being to request enrollment 302 in the known group(s).

Enrollee 102 is also shown the terms and any fees 308 that may be applicable. Enrollee 102 has the option to cancel the enrollment process 300 through step 306 at any time before a token 136 is dispensed or an image capture 314 is made.

If enrollee 102 agrees in step 310 to continue the process 300, the enrollee is provided the option 312 to provide biometric data. If accepted in step 312, the biometric data is captured in step 314. The preferred embodiment at this time is the face image capture.

The biometric image from step 314 is analyzed 316 and if determined to be acceptable in step 318, the biometric record is secured in storage step 322, preferably by image server 164.

In a case where step 318 determines that the biometric capture was unsuccessful, a determination can be made in step 320 whether to retry the capture. If a retry is allowed, the process returns to step 314. If a maximum retry count has already been met at step 320, then the failure is noted in step 323.

Enrollee 102 is presented further options on screen 110. One option is to request one or more tokens 136 that will identify, for example enrollee 102, the enrollee's luggage (not shown), or the enrollee's family members (e.g., minors). Tokens 136 may also have a dollar value, for example for use to place a wager. If enrollee 102 chooses this option in step 324, then the token inventory 134 is checked in step 326. If sufficient tokens are present, the token(s) are prepared in step 328. In the preferred embodiment, a pre-counted, serialized number of token(s) 136 from inventory 134 is registered to the account of enrollee 102. Then in dispensing step 330, that pre-counted number of tokens 136 is provided to enrollee 102. In the preferred embodiment the dispenser 132 is the ATM cash dispenser drawer. When tokens are dispensed, the process continues at storage step 338, described below.

The enrollee can be offered to have additional tokens 136′ sent or shipped in step 332. This selection is necessary if inventory 134 is exhausted, or kiosk 100 does have a dispenser 132 suitable for tokens 136. If accepted in step 334, the tokens 136′ will be prepared/written at a remote site 131 and sent in step 336.

In storage step 338, regardless of the dispensing means, a record of the secure tokens 136 and/or 136′ will be kept in the database 160. Thus, the tokens 136′ shipped in step 336 from the fulfillment center 131 will match the same data in ID database 160 as tokens 136 dispensed in step 330 at the kiosk 100.

In another embodiment, kiosk 100 has a barcode or RFID writer, and the biometric ID data collected in storage step 322 is written to tokens 136. Additional tokens 136′, besides matching the same data as kiosk tokens 136, could also have the biometric data stored in step 322 written to them at the remote site 131 in step 336. This record also will be secured in the database 160 in storage step 338.

Enrollee 102 can also elect to input additional personal identification data in step 340, such as phone number, cell number, zip code, driver's license number, passport number, etc. This data can be entered by using the keypad/card reader 114 at the enrollment kiosk 100 in step 342. Enrollee 102 may also elect, when prompted during step 342, to insert additional magnetic stripe cards (not shown), such as credit cards, driver's license, etc., into the keypad/card reader 114 as additional personal data that may be required for the process 300. The data acquired in step 342 is secured to the record in the database 160, in storage step 344, and may be correlated with at least one other database 168, including pre-existing records in the secure ID database 160.

This process 300 may be paused at any point, and continued at a later time, saving all data in storage step 344, and enrollee 102 may resume the process 300 with the additional personal identification data 342, or magnetic stripe cards, needed to complete the enrollment process 300.

It is contemplated that some driver's licenses and other personal identification cards/tokens may be optically encoded, such as a barcode. The preferred embodiment uses the kiosk 100 hardware as is prevalent throughout the globe, with as few hardware changes as possible; however, using other card data capture means is contemplated, such as optical, radio frequency, etc., when and if available at the enrollment sites 100.

Finally, a receipt is printed in step 350, the transaction presents a concluding message to enrollee 102 in concluding step 352 and enrollment process 300 completes at step 354.

When enrollee 102 is not recognized at step 304, or when enrollee 102 does not accept 310 the terms 308, then the transaction is canceled at step 306. Preferably, a receipt is printed as in step 350 which provides hard copy of the direction to an applicant process, as in step 305.

Referring to FIG. 4, which describes the enrollee purchase of an itinerary or an event and the data pre-fetch process 400 that occurs prior to enrollee presenting at the checkpoint and/or transaction point.

In one travel-related preferred embodiment, enrollee 102 purchases a ticket in step 402 for a planned itinerary or an event. The purchase mechanism is not shown, but may include in-person (ticket counter), telephone, or online (Internet) purchases. The purchase is registered in at least one remote location, preferably including ID database 160 and the schedule server 240.

The departure/event location, date and time is noted in storage step 404.

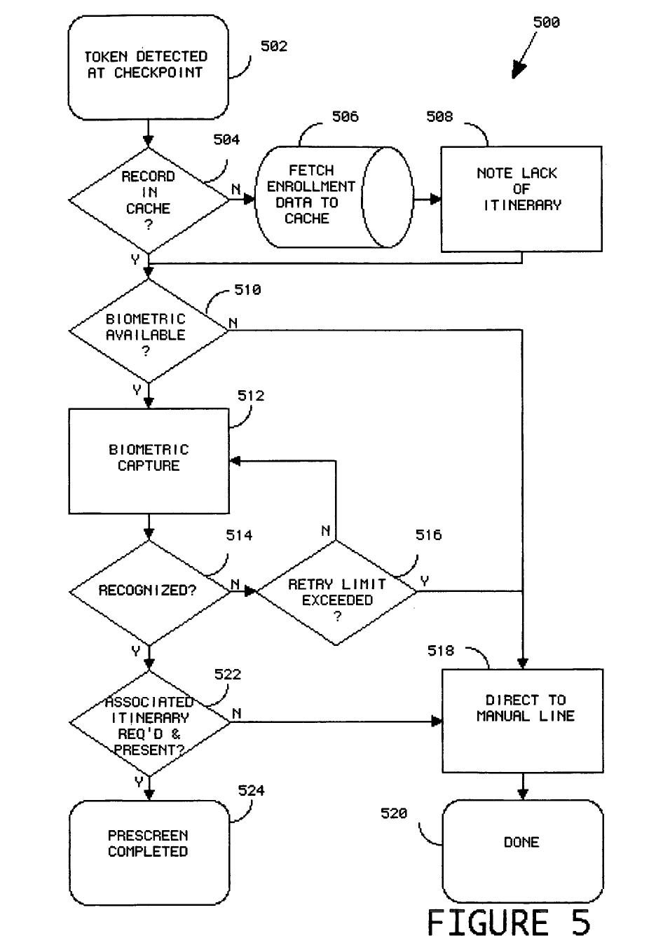

In order to streamline the screening process 500 (discussed in conjunction with FIG. 5), the enrollee data from ID database 160 is pre-fetched sometime before the departure date and time (as indicated by delay step 406) and cached in step 408 in schedule server 240.

The pre-fetch of step 408 is preferably initiated by schedule server 240, but may be initiated from any system having the record from step 404.

In the preferred embodiment, pre-fetch step 408 additionally comprises comparing the enrollee's personal ID data from database 160 against other databases 168, to detect issues previously mentioned, such as the enrollee being on a no-fly or no-entry list.

The data is held in cache until departure date 406. At some predetermined time after the event/travel date and time, the cache data expires in step 410.

The pre-fetch process concludes in step 412.

This record can be saved in the secure database 160 as a history of enrollee 102 activity.

FIG. 5 is the potential enrollee 202 screening process, allowing access to an enrollee 102 and denying access to an unknown person.

In the preferred embodiment, the potential enrollee 202 arrives at a designated (by signage 204) access checkpoint 200. Tokens 136 (or 136′) that are present in the potential enrollee's 202 car, or on the enrollee's person, or in the enrollee's luggage are detected in step 502 at a checkpoint 200 by sensor 226. The pre-fetch cache is examined for token 136 or 136′ data in step 504. If not found, enrollee's 202 data is fetched in step 506. If no cached data had been present for the potential enrollee 202 in step 504, then a note is made to the cache in step 508, that no itinerary was present upon arrival. Preferably this note is stored in at least one location, including at least the schedule server 240 and the security database 160.

At substantially the same time as a token is detected in step 502 when the potential enrollee 202 passes into the token reader's 224 scan zone 228, the cache is checked for the enrollee's 202 biometric data in step 510. If biometric data is available in step 510, then the system attempts a biometric image capture in step 512 of the potential enrollee 202. If successfully compared to biometric data from ID database 160 (preferably previously fetched and now held in cache), then the potential enrollee 202 is recognized at step 514 as an enrollee 102. If the enrollee's itinerary is present and matched in step 522, then the now-recognized enrollee 202 is allowed access to the known persons' area and the prescreen process 500 is completed successfully in step 524.

If there is no token 136 or 136′ on or with the potential enrollee 202 at step 502, the person is directed to a manual screening in step 518.

If there is a token 136 or 136′ but the potential enrollee's 202 biometric data are not recognized in step 514, there may be a set number of match retry attempts through decision step 516 before the potential enrollee 202 is directed to the unknown persons' area in step 518 for manual screening.

Similarly, though an enrollee 202 may be recognized in step 514 and have tokens 136/136′ detected in step 502, if there is no itinerary on record for them at step 522, then the enrollee is directed in step 518 to a manual screening, after which process 500 concludes at step 520.

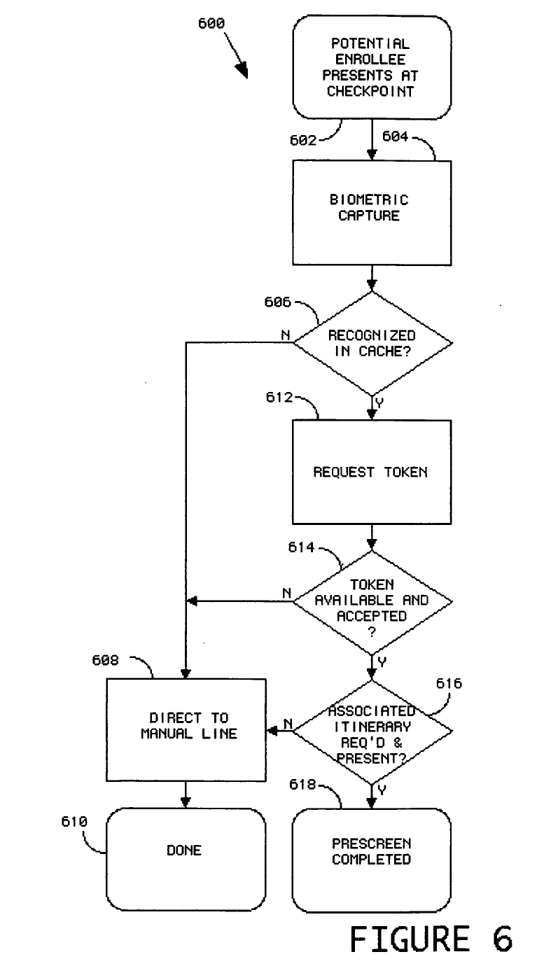

FIG. 6 describes an alternate method for screening and confirming that a potential enrollee 202 is in fact a known enrollee 102.

The potential enrollee 202 arrives at a designated 204 checkpoint 200. The enrollee's biometric data are captured in step 604 and an attempted to match is made to data in cache in step 606. If recognized in step 606, the potential enrollee's 202 token is requested in step 612 and, in the preferred embodiment, scanned by the RFID token reader 224. The potential enrollee 202 might possess another token, such as a barcode, or bank or ATM card, or driver's license, any of which may be inserted into the keypad/card reader 214. Also, additional screening and matching could take place at the keypad/card reader 214, if one or more scans are unacceptable.

If token(s) 136 or 136′ are accepted in step 614, and matched to the event/itinerary in step 616, then the pre-screen is completed successfully in step 618 and enrollee 202 is directed to the known enrollee's area.

If the token(s) are not accepted at step 614, or the associated itinerary is not present at step 616, or biometric data was not recognized at step 606, then the potential enrollee 202 is directed in step 608 to the unknown persons' area and the pre-screen is complete in step 610.

The particular features of the user interface and the performance of the application will depend on the architecture used to implement a system of the present invention, the operating system of the computers selected, the communications channel selected, and the software code written. It is not necessary to describe the details of such programming to permit a person of ordinary skill in the art to implement an application and user interface suitable for incorporation in a computer system within the scope of the present invention. The details of the software design and programming necessary to implement the principles of the present invention are readily understood from the description herein. Various additional modifications of the described embodiments of the invention specifically illustrated and described herein will be apparent to those skilled in the art, particularly in light of the teachings of this invention. It is intended that the invention cover all modifications and embodiments, which fall within the spirit and scope of the invention. Thus, while preferred embodiments of the present invention have been disclosed, it will be appreciated that it is not limited thereto but may be otherwise embodied within the scope of the claims.

I claim:

1. A method for enrolling a member of a first group into a second group, comprising the steps of:
a) providing a database;
b) providing a kiosk, said kiosk having communication with said database through a communication channel, said kiosk able to accept from said member first identification, said first identification consisting of a card and a code, said code having a predetermined association with said card, said first identification to verify that said member belongs to said first group;
c) accepting with said kiosk from said member said first identification;
d) verifying with said kiosk on the basis of said first identification that said member belongs to said first group by querying said database;
e) receiving with said kiosk from said member an indication that said member desires to enroll in said second group;
f) associating said first identification with data representative of a second identification in said database, said second identification belonging to said member, thereby creating an association;
whereby said member is enrolled in said second group and can be identified by at least one of said first identification and said second identification.

2. The method of claim 1 wherein said kiosk is an ATM, said code is a PIN, and said card is a bankcard.

3. The method of claim 1 wherein said second identification is a telephone number.

4. The method of claim 1 wherein said second identification is at least one of a driver's license and a passport.

5. The method of claim 1, wherein said kiosk further comprises a dispenser for said second identification and further comprising the step of:
g) dispensing said second identification to said member with said kiosk.

6. The method of claim 5, wherein said second identification comprises at least one selected from an RFID and a barcode.

7. The method of claim 1, further comprising the steps of:
g) providing a fulfillment center for dispensing said second identification; and,
h) dispensing said second identification to said member from said fulfillment center.

8. The method of claim 7, wherein said second identification comprises at least one selected from an RFID and a barcode.

9. The method of claim 1, further comprising the step of:
g) capturing with said kiosk from said member said second identification.

10. The method of claim 9 wherein said kiosk comprises a biometric sensor and said second identification comprises biometric data.

11. The method of claim 10 wherein said biometric sensor is a camera and said biometric data is a facial image of said member.

12. The method of claim 10, further comprising the steps of:
h) providing a checkpoint, said checkpoint able to accept said first identification and detect said second identification, said checkpoint in communication with said database and thereby able to verify said association;
i) accepting said first identification from said member with said checkpoint;
j) detecting said second identification from said member with said checkpoint; and
k) allowing access to said member with said checkpoint if said association is present in said database.

13. The method of claim 10, further comprising the steps of:
h) providing a transaction site, said transaction site able to accept said first identification and detect said second identification, said transaction site in communication with said database and thereby able to verify said association;
i) accepting said first identification from said member with said transaction site;
j) detecting said second identification from said member with said transaction site; and
k) allowing a transaction by said member with said transaction site if said association is present in said database.

14. The method of claim 10 further comprising the steps of:
h) dispensing a third identification to said member; and,
i) writing data representative of at least a portion of said biometric data to said third identification.

15. The method of claim 14 further comprising the steps of:
j) providing a checkpoint, said checkpoint able to detect said second identification and read the data from said third identification, said checkpoint able to determine a substantial match between said second identification and the data from said third identification;
k) detecting said second identification from said member with said checkpoint;
l) reading the data from said third identification with said checkpoint; and,
m) allowing access to said member with said checkpoint if said second identification substantially matches said data from said third identification.

16. The method of claim 14 further comprising the steps of:
j) providing a transaction site, said transaction site able to detect said second identification and read the data from said third identification, said transaction site able to determine a substantial match between said second identification and the data from said third identification;
k) detecting said second identification from said member with said transaction site;
l) reading the data from said third identification with said transaction site; and,
m) allowing a transaction by said member with said transaction site if said second identification substantially matches said data from said third identification.

17. The method of claim 10, further comprising the steps of:
h) providing a dispensing means operable to dispense a third identification, said third identification comprising at least one of an RFID and a barcode;
i) dispensing said third identification to said member with said dispensing means;
j) creating a second association in said database between said third identification and data representative of at least a portion of said second identification;
k) providing a checkpoint, said checkpoint able to detect said third identification and detect said second identification, said checkpoint in communication with said database and thereby able to verify said second association;
l) detecting said third identification in possession of said member with said checkpoint;
m) detecting said second identification from said member with said checkpoint; and
n) allowing access to said member with said checkpoint if said second association is present in said database.

18. The method of claim 10, further comprising the steps of:
h) providing a dispensing means operable to dispense a third identification, said third identification comprising at least one of an RFID and a barcode;
i) dispensing said third identification to said member with said dispensing means;
j) creating a second association in said database between said third identification and data representative of at least a portion of said second identification;
k) providing a transaction site, said transaction site able to detect said third identification and detect said second identification, said transaction site in communication with said database and thereby able to verify said second association;
l) detecting said third identification in possession of said member with said transaction site;
m) detecting said second identification from said member with said transaction site; and
n) allowing a transaction by said member with said transaction site if said association is present in said database.

19. A system for securely enrolling a member of a first group into a second group, the system comprising:
a kiosk;
a database, said database having an account belonging to said member, said account corresponding to said first identification;
a communication channel, said kiosk having communication with said database through said communication channel;
said kiosk having a first reader, said first reader able to accept a first identification from said member;
said kiosk having a second reader, said second reader able to capture a second identification from said member;
said kiosk further able to create an association between said second identification and said first identification in said database, whereby said member is enrolled in said second group.

20. A system for securely enrolling a member of a first group into a second group, the system comprising:
a kiosk;
a database, said database having an account belonging to said member, said account corresponding to said first identification;
a communication channel, said kiosk having communication with said database through said communication channel;
said kiosk having a first reader, said first reader able to accept a first identification from said member;
said kiosk having a second reader able to capture a second identification from said member, said second reader comprising a biometric sensor, said second identification comprising biometric data;
said kiosk having a dispenser, said dispenser able to dispense a third identification to said member; said kiosk further able to create an association between said second identification and said third identification in said database; a checkpoint, said checkpoint having a third reader able to detect said second identification from said member, said checkpoint further having a fourth reader able to read said third identification, said checkpoint having communication with said database through said communication channel, said checkpoint allowing access to said member if said association is present in said database.
